(19) United States
(12) Patent Application Publication
(10) Pub. No.: US 2008/0258455 A1
(43) Pub. Date: Oct. 23, 2008

(54) Portable record system for a decorating scheme

(76) Inventor: Catherine Solich, Cape Coral, FL (US)

Correspondence Address: Catherine Solich, 829 SW 15th Ave, Cape Coral, FL, 33991, US

(21) Appl. No.: 12/080,635

(22) Filed: Apr. 3, 2008

Related U.S. Application Data
(60) Provisional application No. 60/923,451, filed on Apr. 13, 2007.

(51) Int. Cl. B42D 15/00

(52) U.S. Cl. 283/74

(57) ABSTRACT

A decorating scheme is disclosed which involves a bundle of flat and durable sticks which identify the various decorative schemes that have been applied to a certain room, on what date and the brand, quality and type of the decorative item that have been used and where the items were bought.

This application is a Continuation-In-Part of a Provisional Application No. 60/923,451 filed on Apr. 13, 2007

### BACKGROUND OF THE INVENTION

The inventive concept solves a long-standing problem and that is to identify a paint job and the paint color used in a certain location whether that is indoor or outdoor. Once a room, for example has been painted and possibly in different colors, that is, the ceiling was painted in one color and the walls and in a different color and possibly the wood work in a third color. It is extremely difficult, after a certain time has elapsed, to remember a particular color. To take paint chips to a paint store to be identified there, may be an impossible task because the color may have changed over a certain time span. The color has changed by soiling or be fading. The home owner may have thrown out the empty or almost empty paint cans and, therefore, there is no indication left of the brand of paint and/or the store where the paint was bought. This becomes a particular problem if one wants to touch up certain spots in a location without having to repaint the whole room or location.

### BRIEF DESCRIPTION OF THE INVENTION

The inventive concept solves the above noted problems by using a very simple and long lasting identification system that will on one piece of durable material identify the room or location which has been painted, the date it was painted, the brand of the paint, the color coding or formula of the paint and the store where the paint was bought. The system will also identify the wall paper that was hung, a swatch of a carpet installed or a swatch of a vinyl flooring and a swatch of fabric to identify the draperies that were hung on windows.

### BRIEF DESCRIPTION OF THE DRAWINGS

FIG. 1 shows a bundled paint identification system having individual location identifiers in the form flat sticks;

FIG. 2 illustrates a variation of the system of FIG. 1 identifying different decoration schemes.

### DETAILED DESCRIPTION OF THE INVENTION

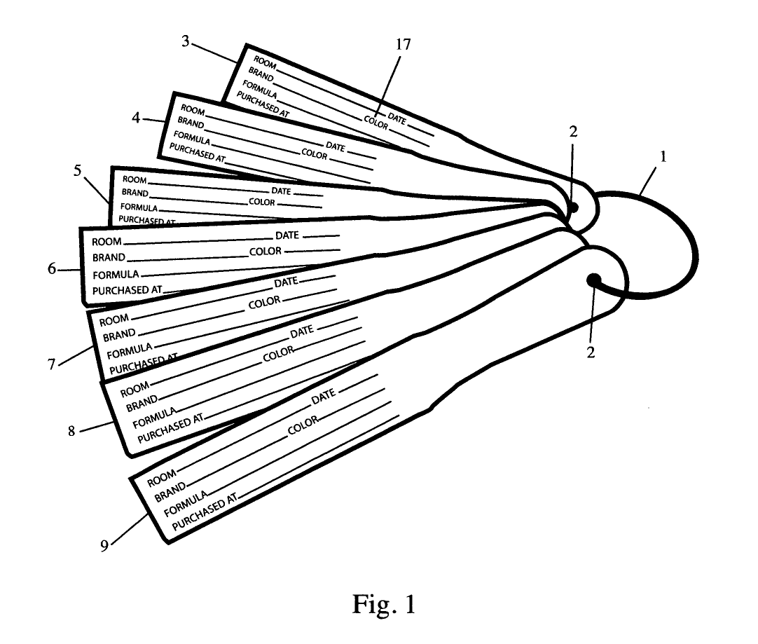

FIG. 1 illustrates the inventive paint identification system by bundling a plurality of flat sticks 3-9 together on a ring 1, a chain or any other device capable of bundling. The flat sticks can be made of any durable material such as wood, plastic, card board or even stiff paper. Each of the flat sticks has hole 2 therein to enable the same to be bundled. Each of the flat sticks has printed matter 17 thereon.

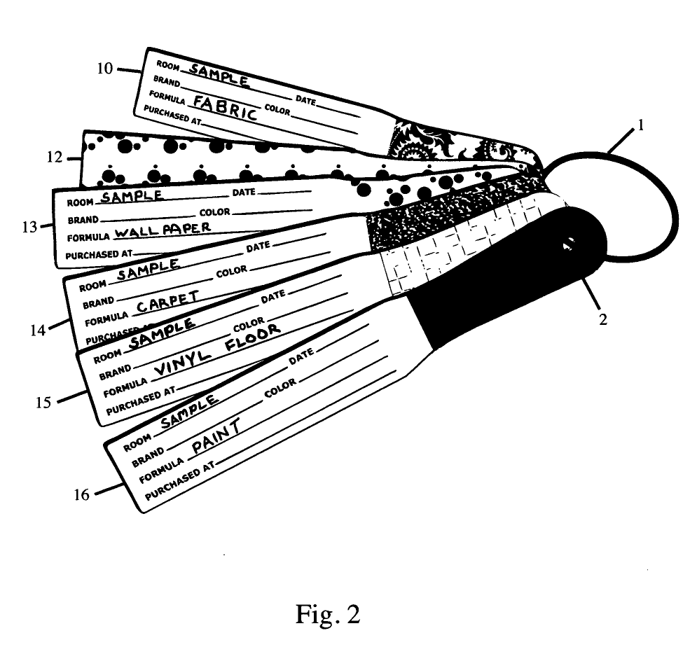

FIG. 2 illustrates a different scheme of using the flat sticks of FIG. 1 to identify various decorating tasks. Thus, for example, similar sticks of FIG. 1 are used to identify various decorative tasks or identifiers that have been used. FIG. 10 has a swatch of fabric attached thereto to identify the fabric used in making draperies. FIG. 12 and 13 identify the wallpaper on the walls of a room. FIG. 14 shows a swatch of carpet attached thereto. FIG. 15 has a piece of the vinyl flooring attached thereon. FIG. 16 illustrates a the paint that has been used in a particular room. In all of theses samples, the various decorative schemes have been placed at the end of each of the sticks. The other side of the sticks can be used just as well to identify the various decorative schemes. If a back side is used a larger specimen can be displayed.

### Operation

When a location is to painted, and the paint and color has been chosen, the vital information should be entered on the flat stick 7. When identifying the room, the particular application should also be entered such as, for example, ceiling, walls, woodwork, doors, windows and molding. The store could be most helpful in identifying the brand, the color and or the code or formula. The purchase location should be clear and understood. When starting to paint and the paint has been thoroughly mixed, it is advisable to apply the paint to another end of the flat stick or at the back thereof for future identification.

It now becomes clear that, after a certain period of time, one is always assured that the same paint can be applied as a touch up or a repaint. By bundling the various sticks together a whole house paint scheme can always be ready for identification. It would also be a great asset when selling a house to a new owner which would remove all guessing as to what paint was used and where it was bought.

Paint stores should have a supply of these paint identifiers in stock and it would also be a great help for them to assure future or repeat business.

This decorating scheme also includes swatches of carpet samples, wallpaper samples, fabric samples and vinyl samples. These samples can be taken to a paint store and a computer can determine the proper paint color or suggestions of paint colors.

This, then makes it clear that a compact scheme has been developed that makes the decorating of a home extremely easy without the use of professional decorators.

What I claim is:

1. A record system for a decorating identifier comprising a durable flat stick, said stick having on one side thereof indicia pertaining to information where the decorative identifier was applied and on what date, the brand of the identifier and its color and formula and the location of the store where bought and what kind of paint to obtain.

2. The record system of claim 1, wherein the durable material is selected from the group consisting of wood, plastic, cardboard or stiff paper.

3. The record system of claim 1, wherein said durable flat stick has a hole in one end thereof.

4. The record system of claim 3, wherein said hole in one end thereof is utilized to bundle a multiple of flat sticks together to identify a multiple of decorating locations.

5. The record system of claim 1, wherein said decorating identifier is selected from the group consisting of paint color, a carpet swatch, a wallpaper sample, a fabric swatch or a vinyl material sample.
